(19) United States
(12) Patent Application Publication
(10) Pub. No.: US 2023/0162308 A1
(43) Pub. Date: May 25, 2023

(54) ACCOMMODATION MEASURE EVALUATION DEVICE, ACCOMMODATION MEASURE EVALUATION PROGRAM, AND ACCOMMODATION MEASURE EVALUATION METHOD

(71) Applicant: IDEPENDENT-URARA LIMITED LIABILITY COMPANY, Chiyoda-ku, Tokyo (JP)

(72) Inventors: Takayuki HONGO, Nagasaka-cho, Hokuto-shi, Yamanashi (JP); Akane SHINOHARA, Chiyoda-ku, Tokyo (JP)

(73) Assignee: IDEPENDENT-URARA LIMITED LIABILITY COMPANY, Chiyoda-ku, Tokyo (JP)

(21) Appl. No.: 17/754,802

(22) PCT Filed: Oct. 8, 2020
(86) PCT No.: PCT/JP2020/039200

§ 371 Date: Apr. 13, 2022

(30) Foreign Application Priority Data
Oct. 18, 2019 (JP) 2019-201823

(51) Int. Cl. G06Q 50/26; G09B 21/00

(52) U.S. Cl. CPC G06Q 50/265; G09B 21/007; G09B 21/009

(57) ABSTRACT

A device and a method storing accommodation measure evaluation data that associates an accommodation measure for a person in a minority group with evaluation of the accommodation measure are provided. When the accommodation measure to be provided for the person in the minority group is input, an evaluation of the accommodation measure to be provided is acquired based on the input accommodation measure and the accommodation measure evaluation data, and the evaluation is displayed on a display monitor or the like. Furthermore, a higher evaluation is given to a specific accommodation measure (first accommodation measure) than another accommodation measure (second accommodation measure), which enables the more detailed evaluation to be performed.

### TECHNICAL FIELD

The present disclosure relates to a device and the like for enhancing an accommodation measure to persons called social minorities (social minority group) such as persons with disabilities, foreign nationals, and elderly persons.

### BACKGROUND ART

With the enforcement of Act for Eliminating Discrimination against Persons with Disabilities, entities, facilities, and companies that accept persons with disabilities are obliged to give a reasonable accommodation to the persons with disabilities.

Further, in order to implement the inclusive society, regardless of the presence or absence of such the law, various accommodations are naturally needed to be given to persons in minority groups called social minorities (persons with disabilities, elderly persons, foreign nationals, and the like).

### Citation List

### Non Patent Literature

Since no mechanism has been proposed so far to evaluate the reasonable accommodation, the prior art documents cannot be specified.

### SUMMARY OF INVENTION

### Technical Problem

However, since persons called social minorities often have special circumstances, entities, facilities, and companies that accept the social minorities currently do not know what kind of accommodation is supposed to be given or what kind of accommodation would be the reasonable accommodation.

Further, determination criteria to determine whether the reasonable accommodation is sufficiently given is currently not known at all.

Therefore, the present disclosure provides the entities, facilities, companies, and the like that accept social minorities with a device and the like for evaluating what kind of accommodation is appropriate and what kind of accommodation measure is supposed to be taken to reach the reasonable accommodation (whether certain criteria for winning the recognition that a reasonable accommodation has been taken is satisfied).

### Solution to Problem

In order to solve the above problems, the present disclosure provides a device including the following units, a program that causes a computer to function as the following units, and a method in which the computer performs the following steps.

An accommodation measure evaluation data acquisition unit configured to acquire accommodation measure evaluation data that associates an accommodation measure for a person to be accommodated with an evaluation of the accommodation measure, an accommodation measure acquisition unit configured to acquire the accommodation measure for the person to be accommodated, an evaluation generation unit configured to generate an evaluation of the accommodation measure acquired by the accommodation measure acquisition unit based on the accommodation measure acquired by the accommodation measure acquisition unit and the accommodation measure evaluation data acquired by the accommodation measure data acquisition unit, and an evaluation output unit configured to output the evaluation generated by the evaluation generation unit.

The person to be accommodated comprises a person with disabilities, or an elderly person, or a foreign national.

The accommodation measure comprises barrier-free of a facility or barrier-free of an instrument.

The person to be accommodated comprises a person with disabilities, and the evaluation of the accommodation measure varies in accordance with a type of the disability of the person with disabilities.

The accommodation measure comprises a first accommodation measure and a second accommodation measure, and a higher evaluation is given to an evaluation of the first accommodation measure than an evaluation of the second accommodation measure.

The evaluation varies in accordance with the presence or absence of an emergency accommodation measure that is necessary in an emergency.

The first accommodation measure is the emergency accommodation measure that is necessary in the emergency, and the second accommodation measure is a peacetime accommodation measure that is necessary in peacetime.

The evaluation varies in accordance with the presence or absence of an accommodation measure that is necessary for a physiological phenomenon.

The first accommodation measure is the accommodation measure that is necessary for the physiological phenomenon, and the second accommodation measure is an accommodation measure that is necessary for a non-physiological phenomenon.

The evaluation varies in accordance with the presence or absence of an accommodation measure that is necessary in an excretion action.

The first accommodation measure is the accommodation measure that is necessary in the excretion action, and the second accommodation measure is an accommodation measure that is necessary in a non-excretion action.

The evaluation varies in accordance with the presence or absence of an accommodation measure that is necessary in eating and drinking.

The first accommodation measure is the accommodation measure that is necessary in an eating and drinking action, and the second accommodation measure is an accommodation measure that is necessary in a non-eating and drinking action.

The evaluation varies in accordance with the presence or absence of an audio assist, or varies in accordance with the presence or absence of braille display.

The first accommodation measure is the audio assist, and the second accommodation measure is the braille display.

The evaluation varies in accordance with the presence or absence of provision of character information, or the presence or absence of provision of sign language interpretation.

The first accommodation measure is the provision of the character information, and the second accommodation measure is the provision of the sign language interpretation.

The evaluation varies in accordance with the presence or absence of an accommodation measure with accreditation accredited by a specialized institution or an expert.

The first accommodation measure is the accommodation measure with accreditation accredited by the specialized institution or the expert, and the second accommodation measure is a non-accredited accommodation measure with no accreditation by the specialized institution or the expert.

The evaluation varies in accordance with the presence or absence of provision of a device subjected to automation.

The first accommodation measure is the provision of the device subjected to automation, and the second accommodation measure is provision of a device not subjected to automation.

The device subjected to automation comprises an automatically opening and closing door, an automatic lock door, an elevator, a chair that automatically moves up and down, or a desk that automatically moves up and down.

The evaluation varies in accordance with the presence or absence of an accommodation measure that provides a selection right of a procedure method or an article to the person to be accommodated.

The first accommodation measure is a selection type accommodation measure that provides the selection right to the person to be accommodated, and the second accommodation measure is a non-selection type accommodation measure in which the person to be accommodated has no selection right.

The selection type accommodation measure comprises selection of an information transmission unit, selection of furniture, selection of an office equipment, selection of an office supply including stationery, or selection of a payment system.

The evaluation varies in accordance with the presence or absence of implementation of a training for encouraging an employee or a staff member who accepts the person to be accommodated to understand the person to be accommodated.

The first accommodation measure is the implementation of the training for encouraging the employee or the staff member who accepts the person to be accommodated to understand the person to be accommodated, and the second accommodation measure is non-implementation of the training.

The evaluation varies in accordance with the presence or absence of an accommodation measure that enables adjustment of a lighting device.

The first accommodation measure is the accommodation measure that enables the adjustment of the lighting device, and the second accommodation measure is an accommodation measure incapable of the adjustment of the lighting device.

The evaluation varies as the number of the accommodation measures increases, or the number of types of the accommodation measures increases.

### ADVANTAGEOUS EFFECTS OF INVENTION

By using the present disclosure, an entity or a facility that accepts a social minority, and a company or the like that employs a minority employee can obtain an evaluation of an accommodation measure that is provided by themselves, and can know whether a sufficient accommodation is provided.

Furthermore, a higher evaluation is given to a specific accommodation measure (first accommodation measure) than another accommodation measure (second accommodation measure), which enables the more detailed and more suitable evaluation to be performed.

### BRIEF DESCRIPTION OF DRAWINGS

FIG. 1 is a schematic diagram of a hardware configuration of the present disclosure.

FIG. 2 is a diagram illustrating a process of the present disclosure.

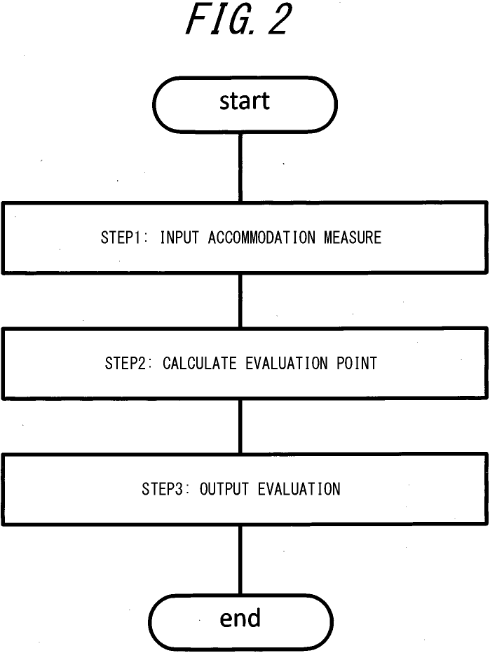

FIG. 3 is a diagram illustrating an input screen and data that are used in a first accommodation measure input process and an evaluation point calculation process.

FIG. 4 is a diagram illustrating an input screen and data that are used in a second accommodation measure input process and the evaluation point calculation process.

FIG. 5 is a diagram illustrating an input screen and data that are used in a third accommodation measure input process and the evaluation point calculation process.

FIG. 6 is a diagram illustrating an input screen and data that are used in a fourth accommodation measure input process and the evaluation point calculation process.

FIG. 7 is a diagram illustrating an input screen and data that are used in a fifth accommodation measure input process and the evaluation point calculation process.

FIG. 8 is a diagram illustrating an input screen and data that are used in a sixth accommodation measure input process and the evaluation point calculation process.

FIG. 9 is a diagram illustrating an input screen and data that are used in a seventh accommodation measure input process and the evaluation point calculation process.

FIG. 10 is a diagram illustrating an input screen and data that are used in an eighth accommodation measure input process and the evaluation point calculation process.

FIG. 11 is a diagram illustrating an input screen and data that are used in a ninth accommodation measure input process and the evaluation point calculation process.

FIG. 12 is a diagram illustrating an input screen and data that are used in a tenth accommodation measure input process and the evaluation point calculation process.

FIG. 13 is a diagram illustrating an input screen and data that are used in an eleventh accommodation measure input process and the evaluation point calculation process.

FIG. 14 is a diagram illustrating an input screen and data that are used in a twelfth accommodation measure input process and the evaluation point calculation process.

FIG. 15 is a diagram illustrating a reasonable accommodation achievement reference point and an evaluation display screen.

FIG. 16 is a diagram illustrating a database for varying the evaluation in accordance with the type of the disability.

### DESCRIPTION OF EMBODIMENTS

### Example

An example 1 of the present disclosure will be described with reference to the drawings.

Firstly, a configuration example of a hardware that is used in this example will be described.

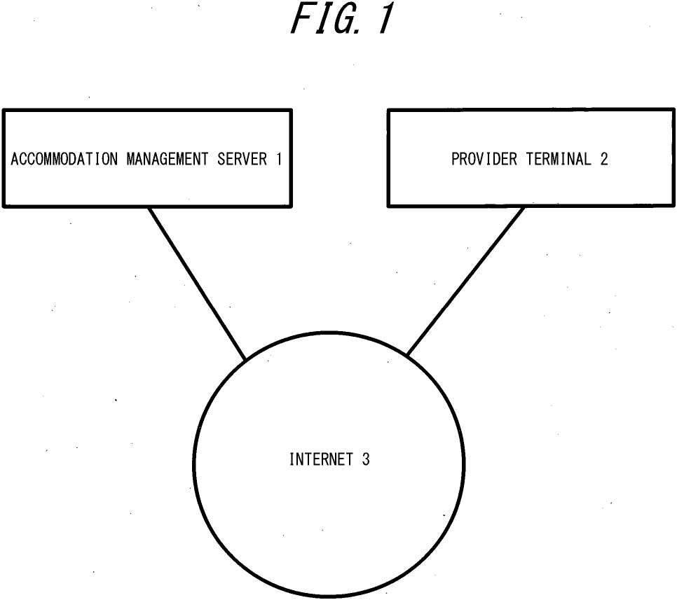

FIG. 1 is a schematic diagram of a hardware configuration of the present disclosure.

The present disclosure includes an accommodation management server 1 (a computer) that performs a process on an accommodation measure, and a provider terminal 2 (a computer) that is used by a person in charge on the part of providing an accommodation measure (an entity or a facility that accepts a social minority, a company that employs a minority employee, or the like), and the respective devices (the accommodation management server 1, the provider terminal 2) are connected to each other so that they can transmit and receive information via a communication network such as the Internet 3.

Each device stores a computer program (application software) for implementing the present disclosure and predetermined data, and a processing device incorporated in each device performs a predetermined process according to a processing instruction of the computer program.

Next, respective processing steps of this example will be described.

In this example, an accommodation measure input process (STEP1), an evaluation point calculation process (STEP2), and an evaluation point output process (STEP3) are performed.

The accommodation measure input process (STEP1) is a process, for example, by a person in charge in a company that employs a person with disabilities, of inputting an accommodation measure that is provided to the person with disabilities (the person to be accommodated) by the company.

The evaluation point calculation process (STEP2) is a process of generating and creating, by receiving input data at STEP1, evaluation points of the accommodation measure by the accommodation management server 1.

The evaluation point output process (STEP3) is a process of transmitting and displaying the evaluation points calculated at STEP2 to the provider terminal 2.

Next, an input screen (input method) to be used in each processing step, a processing method of data, and data stored in each device will be described. Here, a case where a person in charge of a company that employs a person with disabilities inputs an accommodation measure that is provided by the company, and obtains an evaluation will be described.

### Evaluation Related to Barrier-Free Measure in Emergency

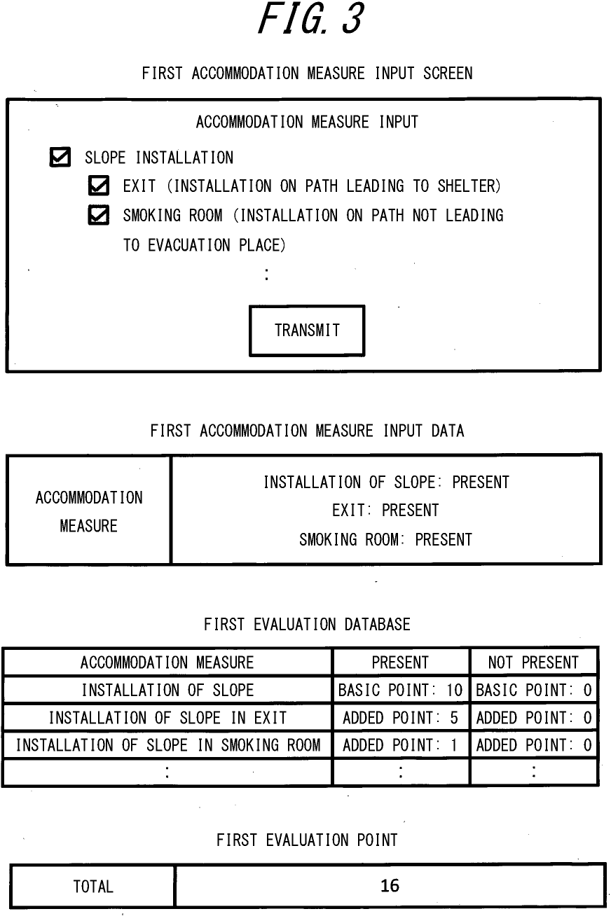

FIG. 3 illustrates a first example of the accommodation measure input process (STEP1) and the evaluation point calculation process (STEP2), and illustrates a first accommodation measure input screen, first accommodation measure input data, a first evaluation database, and a first evaluation point.

### Accommodation Measure Input Process

The first accommodation measure input screen is an information input screen that is used when an accommodation measure (alternatively, an accommodation measure to be provided) that is provided to the employed person with disabilities is input from the provider terminal 2.

The provider terminal 2 accesses the accommodation management server 1 to acquire the first accommodation measure input screen (data that constitutes the input screen), and displays the input screen on a display monitor that is included in the provider terminal 2.

On the first accommodation measure input screen, whether a slope for a wheelchair user is installed (barrier-free of a facility), and when a slope is installed, whether the slope is installed in a path leading to a shelter at the time of disaster (here, an “exit”), and whether the slope is installed in a path not leading to the shelter (here, a general place such as a “smoking room”), are input.

It is assumed that slopes are provided to both of a path leading to a shelter and a path leading to a general place such as a smoking room, in the company. In that case, the person in charge inputs information indicating that the slopes are provided to both (here, three checkboxes are checked), and clicks a send button.

Thus, the provider terminal 2 generates the first accommodation measure input data, and transmits it to the accommodation management server 1.

### Evaluation Point Calculation Process

The accommodation management server 1 that has received the first accommodation measure input data stores it in a storage device (the accommodation measure acquisition unit).

The first evaluation database is stored in the storage device of the accommodation management server 1. This is data serving as a basis for performing an evaluation of an accommodation measure adopted by a company and in which each accommodation measure for a person to be accommodated is corresponded (associated) with a corresponding score (an evaluation serving as an element of a final determination evaluation: an evaluation element), and is acquired by the accommodation management server 1 through a predetermined process (the accommodation measure evaluation data acquisition unit).

The accommodation management server 1 searches and extracts each score (a score including a basic point and an added point) based on the received first accommodation input data. In other words, the corresponding “basic point: 10” is extracted for “installation of slope: present”, the corresponding “added point: 5” is extracted for “installation of slope in exit: present”, and the corresponding “added point: 0” is extracted for “installation of slope in smoking room: present”.

Next, the accommodation management server 1 sums up the searched and extracted scores, and generates and creates the “first evaluation point: 15” (the evaluation generation unit).

Thus, an accommodation measure that is adopted by the company and the like can be appropriately evaluated, and a suitable accommodation can be provided to persons in the minority groups.

Further, in this example, an emergency accommodation measure (first accommodation measure) that is necessary in an emergency including the time of disaster and a peacetime accommodation measure (second accommodation measure) that is necessary at the time other than in the emergency, in other words, that is necessary in peacetime are distinguished from each other, and a higher evaluation point is given to the emergency accommodation measure than the peacetime accommodation measure (when the first accommodation measure is adopted, a high evaluation is given thereto by adding points). Thus, even when persons in the minority groups face a life-threatening situation, a suitable accommodation can be provided, for example, the persons can be appropriately evacuated and rescued.

### Evaluation Related to Barrier-Free Measure Related to Excretion Treatment of Toilet and the Like

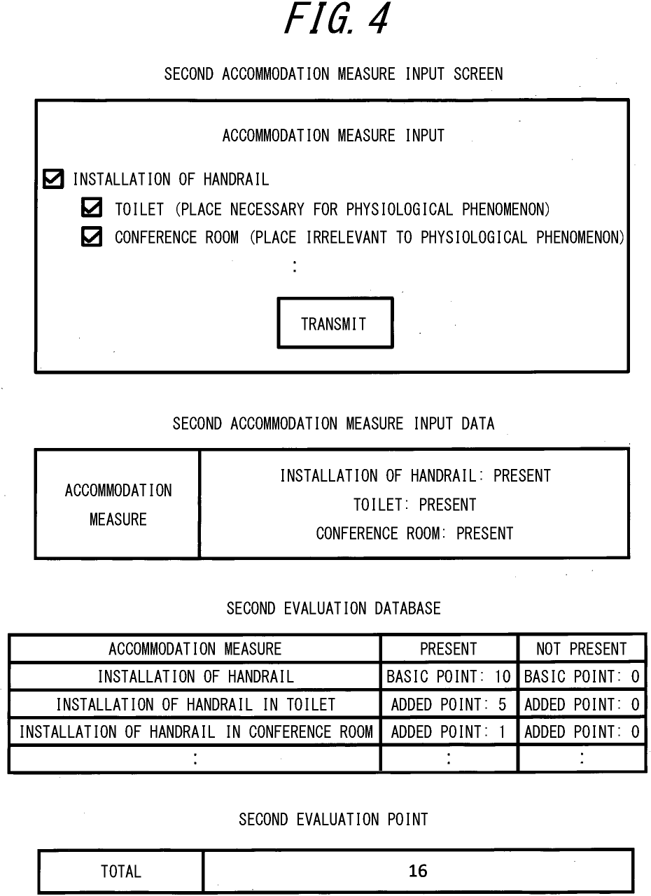

FIG. 4 illustrates a second example of the accommodation measure input process (STEP1) and the evaluation point calculation process (STEP2), and illustrates a second accommodation measure input screen, second accommodation measure input data, a second evaluation database, and a second evaluation point.

### Accommodation Measure Input Process

The second accommodation measure input screen is an information input screen that is used when an accommodation measure (alternatively, an accommodation measure to be provided) that is provided to the employed person with disabilities is input from the provider terminal 2.

The provider terminal 2 accesses the accommodation management server 1 to acquire the second accommodation measure input screen (data that constitutes the input screen), and displays the input screen on a display monitor that is included in the provider terminal 2.

On the second accommodation measure input screen, whether a handrail is installed for a person having disability in his/her legs and lower back and having difficulty in walking, whether the handrail is installed in a toilet (a place necessary for a physiological phenomenon such as an excretion action), and whether the handrail is installed in a place (for example, a general place such as a conference room) irrelevant to the physiological phenomenon and the excretion action, are input.

It is assumed that handrails are installed both in a toilet and a general place such as a conference room, in the company. In that case, the person in charge inputs information indicating that the handrails are provided to both (here, three checkboxes are checked), and clicks a send button.

Thus, the provider terminal 2 generates the second accommodation measure input data, and transmits it to the accommodation management server 1.

### Evaluation Point Calculation Process

The accommodation management server 1 that has received the second accommodation measure input data stores it in the storage device.

The second evaluation database is stored in the storage device of the accommodation management server 1. This is data serving as a basis for performing an evaluation of an accommodation measure adopted by the company and in which accommodation measures and corresponding scores are corresponded (associated) with each other, respectively.

The accommodation management server 1 searches and extracts each score (a score including a basic point and an added point) based on the received second accommodation input data (the process is similar to the case of the first evaluation point calculation).

Next, the accommodation management server 1 sums up the searched and extracted scores, and generates and creates the “second evaluation point: 16”.

Thus, an accommodation measure that is adopted by the company and the like can be appropriately evaluated, and a suitable accommodation can be provided to persons in the minority groups.

Further, in this example, an measure (first accommodation measure) that is necessary in a physiological phenomenon including an excretion action and a measure (second accommodation measure) other than the first accommodation measure are distinguished from each other, and a higher evaluation point is given to the measure for the physiological phenomenon including the excretion action than the other accommodation measures (when the first accommodation measure is adopted, a high evaluation is given thereto by adding points). For persons in minority groups, disposal of excreta and the excretion action are especially difficult and sensitive problems. Therefore, a measure for a physiological phenomenon including an excretion action needs to be enhanced, the measure can be implemented in this way, and a suitable accommodation can be prompted.

### Evaluation Related to Barrier-Free Measure for Eating And Drinking

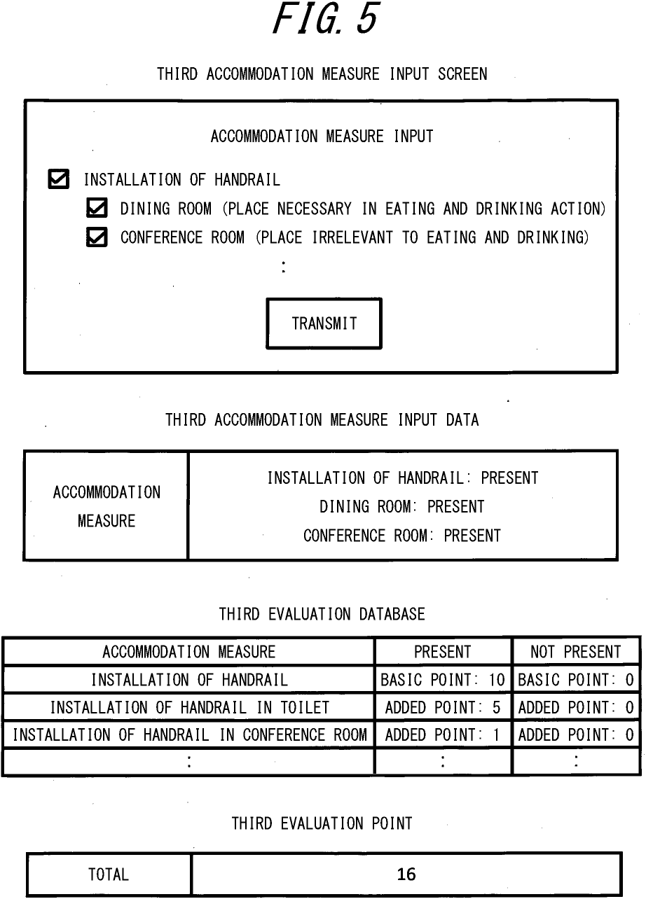

FIG. 5 illustrates a third example of the accommodation measure input process (STEP1) and the evaluation point calculation process (STEP2), and illustrates a third accommodation measure input screen, third accommodation measure input data, a third evaluation database, and a third evaluation point.

### Accommodation Measure Input Process

The third accommodation measure input screen is an information input screen that is used when an accommodation measure (alternatively, an accommodation measure to be provided) that is provided to the employed person with disabilities is input from the provider terminal 2.

The provider terminal 2 accesses the accommodation management server 1 to acquire the third accommodation measure input screen (data that constitutes the input screen), and displays the input screen on a display monitor that is included in the provider terminal 2.

On the third accommodation measure input screen, whether a handrail is installed for a person having disability in his/her legs and lower back and having difficulty in walking, whether the handrail is installed in a dining room (a place necessary for an eating and drinking action), and whether the handrail is installed for a non-eating and drinking action (basically, a place irrelevant to the eating and drinking, for example, a general place such as a conference room), are input.

It is assumed that handrails are installed both in a dining room and a general place such as a conference room, in the company. In that case, the person in charge inputs information indicating that the handrails are provided to both (here, three checkboxes are checked), and clicks a send button.

Thus, the provider terminal 2 generates the third accommodation measure input data, and transmits it to the accommodation management server 1.

### Evaluation Point Calculation Process

The accommodation management server 1 that has received the third accommodation measure input data stores it in the storage device.

The third evaluation database is stored in the storage device of the accommodation management server 1. This is data serving as a basis for performing an evaluation of an accommodation measure adopted by the company and in which accommodation measures and corresponding scores are corresponded (associated) with each other, respectively.

The accommodation management server 1 searches and extracts each score (a score including a basic point and an added point) based on the received third accommodation input data (the process is similar to the case of the first evaluation point calculation).

Next, the accommodation management server 1 sums up the searched and extracted scores, and generates and creates the “third evaluation point: 16”.

Thus, an accommodation measure that is adopted by the company and the like can be appropriately evaluated, and a suitable accommodation can be provided to persons in the minority groups.

Further, in this example, a measure (first accommodation measure) that is necessary in eating and drinking and a measure (second accommodation measure) other than the first accommodation measure are distinguished from each other, and a higher evaluation point is given to the measure for the eating and drinking than the other accommodation measures (when the first accommodation measure is adopted, a high evaluation is given thereto by adding points). For the persons in minority groups, the eating and drinking action is especially important and a sensitive problem, because they might have a food allergy and need to regularly take a meal in order to take a specific medicine after the meal in some cases. Therefore, an accommodation for eating and drinking needs to be enhanced, the enhanced accommodation can be implemented in this way, and a suitable accommodation can be prompted.

### Evaluation Related to Barrier-Free Measure for Person With Impaired Vision

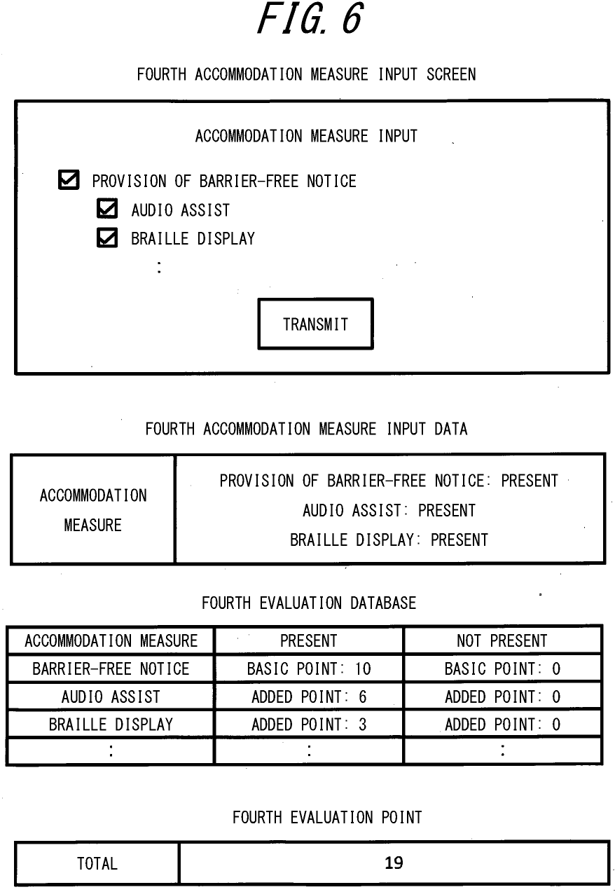

FIG. 6 illustrates a fourth example of the accommodation measure input process (STEP1) and the evaluation point calculation process (STEP2), and illustrates a fourth accommodation measure input screen, fourth accommodation measure input data, a fourth evaluation database, and a fourth evaluation point.

### Accommodation Measure Input Process

The fourth accommodation measure input screen is an information input screen that is used when an accommodation measure (alternatively, an accommodation measure to be provided) that is provided to the employed person with disabilities is input from the provider terminal 2.

The provider terminal 2 accesses the accommodation management server 1 to acquire the fourth accommodation measure input screen (data that constitutes the input screen), and displays the input screen on a display monitor that is included in the provider terminal 2.

On the fourth accommodation measure input screen, whether a barrier-free notice serving as an accommodation for persons with impaired vision is provided, whether the barrier-free notice is an audio assist, and whether the notice is a braille display, are input.

It is assumed that the company provides both of the audio assist and the braille display. In that case, the person in charge inputs information indicating that both are provided (here, three checkboxes are checked), and clicks a send button.

Thus, the provider terminal 2 generates the fourth accommodation measure input data, and transmits it to the accommodation management server 1.

### Evaluation Point Calculation Process

The accommodation management server 1 that has received the fourth accommodation measure input data stores it in the storage device.

The fourth evaluation database is stored in the storage device of the accommodation management server 1. This is data serving as a basis for performing an evaluation of an accommodation measure adopted by the company and in which accommodation measures and corresponding scores are corresponded (associated) with each other, respectively.

The accommodation management server 1 searches and extracts each score (a score including a basic point and an added point) based on the received fourth accommodation input data (the process is similar to the case of the first evaluation point calculation).

Next, the accommodation management server 1 sums up the searched and extracted scores, and generates and creates the “fourth evaluation point: 19”.

Thus, an accommodation measure that is adopted by the company and the like can be appropriately evaluated, and a suitable accommodation can be provided to persons in the minority groups.

Further, in this example, the provision of the audio assist (first accommodation measure) and the provision of the braille display (second accommodation measure) are distinguished from each other as an accommodation for the person with impaired vision, and a higher evaluation point is given to the audio assist than the braille display (when the first accommodation measure is adopted, a high evaluation is given thereto by adding points). Among the persons with impaired vision, a small number of them can understand braille (some investigation results have revealed that among the persons with impaired vision, only 10% of them can understand braille), so that as an accommodation for the persons with impaired vision, the audio assist needs to be regarded as important and promoted. Therefore, the suitable accommodation for the persons with impaired vision can be promoted in this way.

### Evaluation Related to Barrier-Free Measure for Person With Impaired Hearing

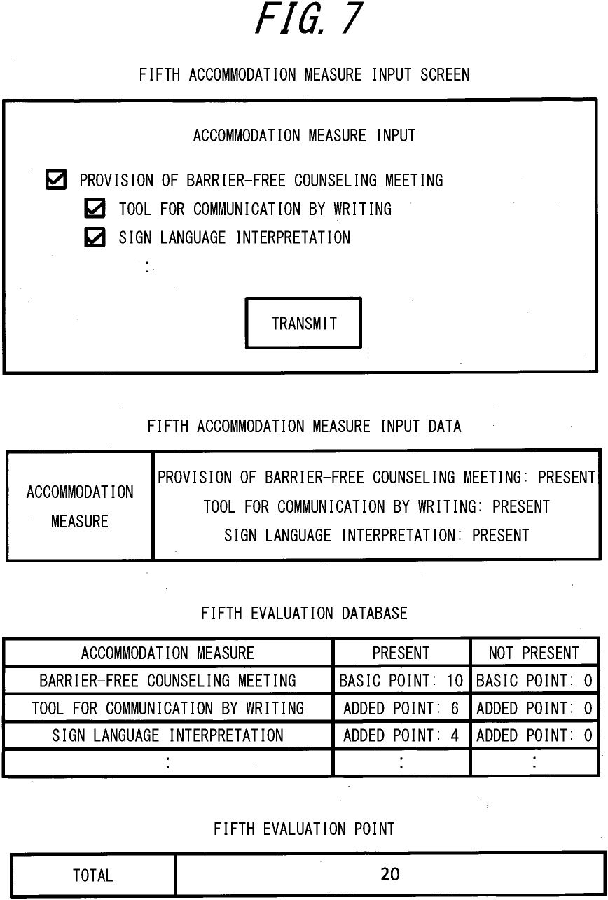

FIG. 7 illustrates a fifth example of the accommodation measure input process (STEP1) and the evaluation point calculation process (STEP2), and illustrates a fifth accommodation measure input screen, fifth accommodation measure input data, a fifth evaluation database, and a fifth evaluation point.

### Accommodation Measure Input Process

The fifth accommodation measure input screen is an information input screen that is used when an accommodation measure (alternatively, an accommodation measure to be provided) that is provided to the employed person with disabilities is input from the provider terminal 2.

The provider terminal 2 accesses the accommodation management server 1 to acquire the fifth accommodation measure input screen (data that constitutes the input screen), and displays the input screen on a display monitor that is included in the provider terminal 2.

On the fifth accommodation measure input screen, whether a barrier-free counseling meeting serving as an accommodation for persons with impaired hearing is provided, whether a tool for communication by writing is provided in the barrier-free counseling meeting (provision of character information), and whether sign language interpretation is provided in the counseling meeting, are input.

It is assumed that the company provides both of the tool for communication by writing and the sign language interpretation. In that case, the person in charge inputs information indicating that both are provided (here, three checkboxes are checked), and clicks a send button.

Thus, the provider terminal 2 generates the fifth accommodation measure input data, and transmits it to the accommodation management server 1.

### Evaluation Point Calculation Process

The accommodation management server 1 that has received the fifth accommodation measure input data stores it in the storage device.

The fifth evaluation database is stored in the storage device of the accommodation management server 1. This is data serving as a basis for performing an evaluation of an accommodation measure adopted by the company and in which accommodation measures and corresponding scores are corresponded (associated) with each other, respectively.

The accommodation management server 1 searches and extracts each score (a score including a basic point and an added point) based on the received fifth accommodation input data (the process is similar to the case of the first evaluation point calculation).

Next, the accommodation management server 1 sums up the searched and extracted scores, and generates and creates the “fifth evaluation point: 20”.

Thus, an accommodation measure that is adopted by the company and the like can be appropriately evaluated, and a suitable accommodation can be provided to persons in the minority groups.

Further, in this example, as an accommodation for the person with impaired hearing, the provision of the tool for communication by writing (first accommodation measure) and the provision of the sign language interpretation (second accommodation measure) are distinguished from each other, a higher evaluation point is given to the provision of the tool for communication by writing than the provision of the sign language interpretation (when the first accommodation measure is adopted, a high evaluation is given thereto by adding points). Among the persons with impaired hearing, a small number of them understands the sign language interpretation (investigation results have revealed that among the persons with impaired hearing, only 20% of them understands), so that as an accommodation for the persons with impaired hearing, the tool for communication by writing needs to be regarded as important and promoted. Therefore, the suitable accommodation for the persons with impaired hearing can be promoted in this way.

Here, the provision of the tool for communication by writing is used as an example of the “provision of character information”, however, the “provision of character information” is not limited to the provision of the tool for communication by writing but may include application of subtitles to a moving image and an image.

### Evaluation Related to Barrier-Free Instrument

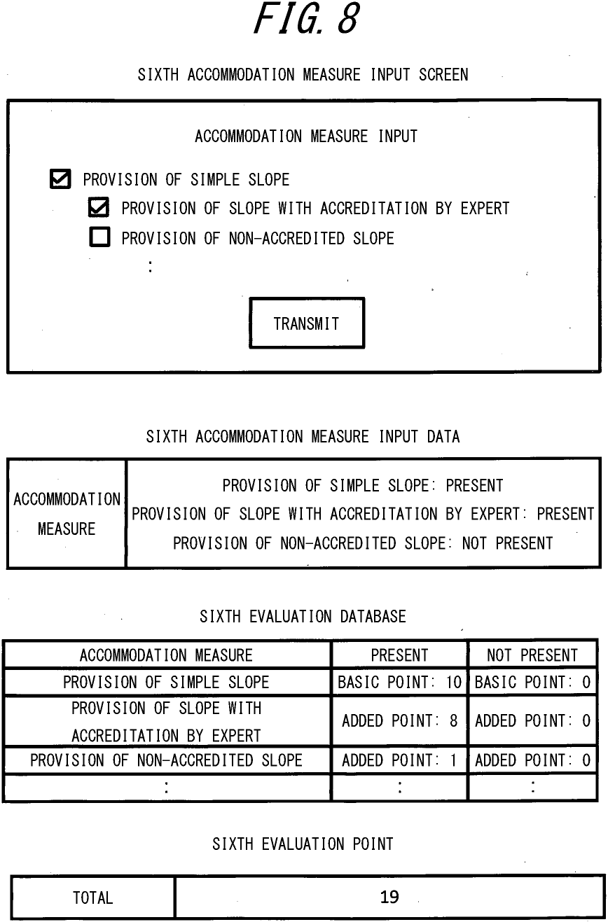

FIG. 8 illustrates a sixth example of the accommodation measure input process (STEP1) and the evaluation point calculation process (STEP2), and illustrates a sixth accommodation measure input screen, sixth accommodation measure input data, a sixth evaluation database, and a sixth evaluation point.

### Accommodation Measure Input Process

The sixth accommodation measure input screen is an information input screen that is used when an accommodation measure (alternatively, an accommodation measure to be provided) that is provided to the employed person with disabilities is input from the provider terminal 2.

The provider terminal 2 accesses the accommodation management server 1 to acquire the sixth accommodation measure input screen (data that constitutes the input screen), and displays the input screen on a display monitor that is included in the provider terminal 2.

On the sixth accommodation measure input screen, whether a simple slope is provided, and when a simple slope is provided, whether the simple slope is a slope accredited by a specialized institution and an expert or is a non-accredited slope not accredited, are input.

It is assumed that the company provides the slope with accreditation. In that case, the person in charge inputs information indicating “the provision of the simple slope” and “the provision of the slope with accreditation by the expert” (here, the corresponding two checkboxes are checked), and clicks a send button.

Thus, the provider terminal 2 generates the sixth accommodation measure input data, and transmits it to the accommodation management server 1.

### Evaluation Point Calculation Process

The accommodation management server 1 that has received the sixth accommodation measure input data stores it in the storage device.

The sixth evaluation database is stored in the storage device of the accommodation management server 1. This is data serving as a basis for performing an evaluation of an accommodation measure adopted by the company and in which accommodation measures and corresponding scores are corresponded (associated) with each other, respectively.

The accommodation management server 1 searches and extracts each score (a score including a basic point and an added point) based on the received sixth accommodation input data (the process is similar to the case of the first evaluation point calculation).

Next, the accommodation management server 1 sums up the searched and extracted scores, and generates and creates the “sixth evaluation point: 19”.

Thus, an accommodation measure that is adopted by the company and the like can be appropriately evaluated, and a suitable accommodation can be provided to persons in the minority groups.

Further, in this example, the provision of the simple slope (barrier-free instrument) accredited by the specialized institution and the expert (first accommodation measure) and the provision of the non-accredited simple slope (second accommodation measure) are distinguished from each other, and a higher evaluation point is given to the simple slope with accreditation than the non-accredited simple slope (when the first accommodation measure is adopted, a high evaluation is given thereto by adding points). Some wheelchairs such as electric wheelchairs are very heavy, and would break a low-strength simple slope, which could cause an accident in some cases. In other words, a person who does not know the barrier-free in detail easily installs the simple slope to cause a very dangerous problem in some cases. Therefore, the use of the barrier-free instrument (a simple slope and the like) accredited by the specialized institution and the expert needs to be regarded as important and promoted. Therefore, the suitable accommodation can be promoted in this way.

### Evaluation Related to Automated Device

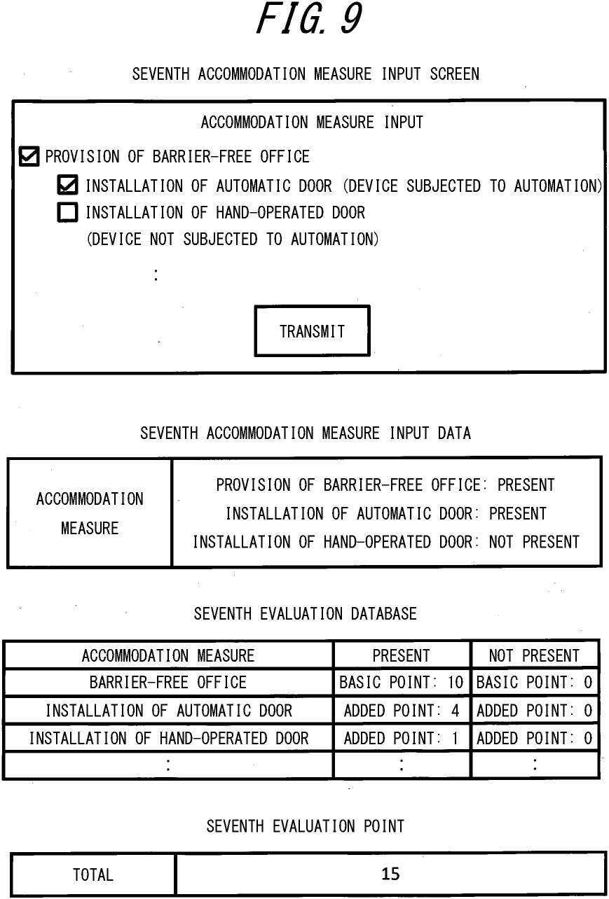

FIG. 9 illustrates a seventh example of the accommodation measure input process (STEP1) and the evaluation point calculation process (STEP2), and illustrates a seventh accommodation measure input screen, seventh accommodation measure input data, a seventh evaluation database, and a seventh evaluation point.

### Accommodation Measure Input Process

The seventh accommodation measure input screen is an information input screen that is used when an accommodation measure (alternatively, an accommodation measure to be provided) that is provided to the employed person with disabilities is input from the provider terminal 2.

The provider terminal 2 accesses the accommodation management server 1 to acquire the seventh accommodation measure input screen (data that constitutes the input screen), and displays the input screen on a display monitor that is included in the provider terminal 2.

On the seventh accommodation measure input screen, whether a barrier-free office is provided, and when a barrier-free office is provided, whether an automatic door (a device subjected to automation) is installed or a hand-operated door is installed, in the office, are input.

It is assumed that the company provides the automatic door. In that case, the person in charge inputs information indicating “the provision of the barrier-free office” and “the installation of the automatic door” (here, the corresponding two checkboxes are checked), and clicks a send button.

Thus, the provider terminal 2 generates the seventh accommodation measure input data, and transmits it to the accommodation management server 1.

### Evaluation Point Calculation Process

The accommodation management server 1 that has received the seventh accommodation measure input data stores it in the storage device. The seventh evaluation database is stored in the storage device of the accommodation management server 1. This is data serving as a basis for performing an evaluation of an accommodation measure adopted by the company and in which accommodation measures and corresponding scores are corresponded (associated) with each other, respectively.

The accommodation management server 1 searches and extracts each score (a score including a basic point and an added point) based on the received seventh accommodation input data (the process is similar to the case of the first evaluation point calculation).

Next, the accommodation management server 1 sums up the searched and extracted scores, and generates and creates the “seventh evaluation point: 15”.

Thus, an accommodation measure that is adopted by the company and the like can be appropriately evaluated, and a suitable accommodation can be provided to persons in the minority groups.

Further, in this example, the installation of the automatic door (first accommodation measure) and the installation of the hand-operated door (second accommodation measure) are distinguished from each other, and a higher evaluation point is given to the installation of the automatic door than the installation of the hand-operated door (when the first accommodation measure is adopted, a high evaluation is given thereto by adding points). It may be difficult for persons with disabilities to manually open and close the door. Therefore, the installation of the automatic door needs to be regarded as important and promoted. Therefore, the suitable accommodation can be promoted in this way.

Here, as a “device subjected to automation”, the “automatic door (automatically opening and closing door)” has been described as an example, however, the “device subjected to automation” is not limited thereto. The device subjected to automation may include an automatic lock door, an elevator, a chair and a desk that move up and down, not manually but automatically, and the like.

### Evaluation Related to Selection of Procedure Method

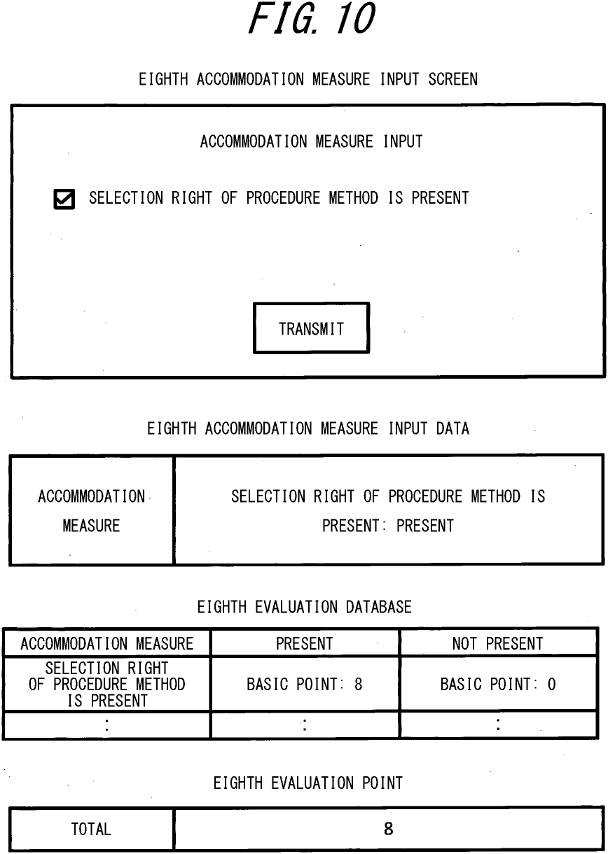

FIG. 10 illustrates an eighth example of the accommodation measure input process (STEP1) and the evaluation point calculation process (STEP2), and illustrates an eighth accommodation measure input screen, eighth accommodation measure input data, an eighth evaluation database, and an eighth evaluation point.

### Accommodation Measure Input Process

The eighth accommodation measure input screen is an information input screen that is used when an accommodation measure (alternatively, an accommodation measure to be provided) that is provided to the employed person with disabilities is input from the provider terminal 2.

The provider terminal 2 accesses the accommodation management server 1 to acquire the eighth accommodation measure input screen (data that constitutes the input screen), and displays the input screen on a display monitor that is included in the provider terminal 2.

On the eighth accommodation measure input screen, the presence or absence of the selection right for the procedure method is input.

In the company, for example, when a request for vacation is performed, persons with disabilities are allowed to select notification methods (procedure methods) that are suitable for the disabilities, such as notification by a document, notification by a telephone, and notification by an electronic mail. Therefore, the person in charge inputs information indicating “the selection right of the procedure method is present” (here, the corresponding checkbox is checked), and clicks a send button.

Thus, the provider terminal 2 generates the eighth accommodation measure input data, and transmits it to the accommodation management server 1.

### Evaluation Point Calculation Process

The accommodation management server 1 that has received the eighth accommodation measure input data stores it in the storage device.

The eighth evaluation database is stored in the storage device of the accommodation management server 1. This is data serving as a basis for performing an evaluation of an accommodation measure adopted by the company and in which accommodation measures and corresponding scores are corresponded (associated) with each other, respectively.

The accommodation management server 1 searches and extracts each score (a score including a basic point and an added point) based on the received eighth accommodation input data (the process is similar to the case of the first evaluation point calculation).

Next, the accommodation management server 1 sums up the searched and extracted scores, and generates and creates the “eighth evaluation point: 8”.

Thus, an accommodation measure that is adopted by the company and the like can be appropriately evaluated, and a suitable accommodation can be provided to persons in the minority groups.

Further, in this example, a case where the selection right of the procedure method is present (first accommodation measure) and a case where the selection right is not present (second accommodation measure) are distinguished from each other, a higher evaluation point is given to the case where the selection right is present than the case where the selection right is not present (when the first accommodation measure is adopted, a high evaluation is given thereto by adding points). For example, in the case of the persons with impaired vision, it is difficult to write in the document of the request for vacation but the notification by the telephone is convenient in some cases, so that adoption of the selectable procedure method needs to be regarded as important and promoted. Therefore, the suitable accommodation can be promoted in this way.

Here, the “selectable procedure method” may include a document, a telephone, an electronic mail, a television conference, and the like. Further, an article such as an instrument may include, for example, stationery and furniture in consideration of the barrier-free.

### Evaluation Related to Implementation of Barrier-Free Workshop

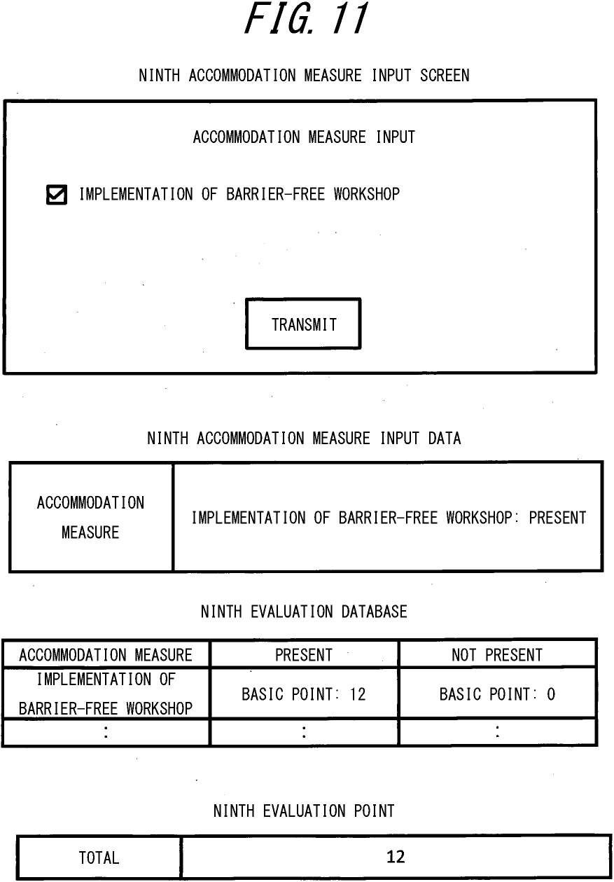

FIG. 11 illustrates a ninth example of the accommodation measure input process (STEP1) and the evaluation point calculation process (STEP2), and illustrates a ninth accommodation measure input screen, ninth accommodation measure input data, a ninth evaluation database, and a ninth evaluation point.

### Accommodation Measure Input Process

The ninth accommodation measure input screen is an information input screen that is used when an accommodation measure (alternatively, an accommodation measure to be provided) that is provided to the employed person with disabilities is input from the provider terminal 2.

The provider terminal 2 accesses the accommodation management server 1 to acquire the ninth accommodation measure input screen (data that constitutes the input screen), and displays the input screen on a display monitor that is included in the provider terminal 2.

On the ninth accommodation measure input screen, whether a barrier-free workshop for developing a better understanding of the persons with disabilities with respect to a staff member who accepts the persons with disabilities and other staff is implemented, is input.

In the company, such a barrier-free workshop is implemented. Therefore, the person in charge inputs information indicating “the implementation of the barrier-free workshop” (here, the corresponding checkbox is checked), and clicks a send button.

Thus, the provider terminal 2 generates the ninth accommodation measure input data, and transmits it to the accommodation management server 1.

### Evaluation Point Calculation Process

The accommodation management server 1 that has received the ninth accommodation measure input data stores it in the storage device.

The ninth evaluation database is stored in the storage device of the accommodation management server 1. This is data serving as a basis for performing an evaluation of an accommodation measure adopted by the company and in which accommodation measures and corresponding scores are corresponded (associated) with each other, respectively.

The accommodation management server 1 searches and extracts each score (a score including a basic point and an added point) based on the received ninth accommodation input data (the process is similar to the case of the first evaluation point calculation).

Next, the accommodation management server 1 sums up the searched and extracted scores, and generates and creates the “ninth evaluation point: 12.

Thus, an accommodation measure that is adopted by the company and the like can be appropriately evaluated, and a suitable accommodation can be provided to persons in the minority groups.

Further, in this example, a case where the barrier-free workshop is implemented (first accommodation measure) and a case where the barrier-free workshop is not implemented (second accommodation measure) are distinguished from each other, and a higher evaluation point is given to the case of the implementation than the case of no implementation (when the first accommodation measure is adopted, a high evaluation is given thereto by adding points). When the persons with disabilities are employed, it is very important for the staff to learn characteristics of the disabilities and accommodations to be provided on a daily basis, so that the implementation of the barrier-free workshop needs to be regarded as important and promoted. Therefore, the suitable accommodation can be promoted in this way.

### Evaluation Related to Lighting Device

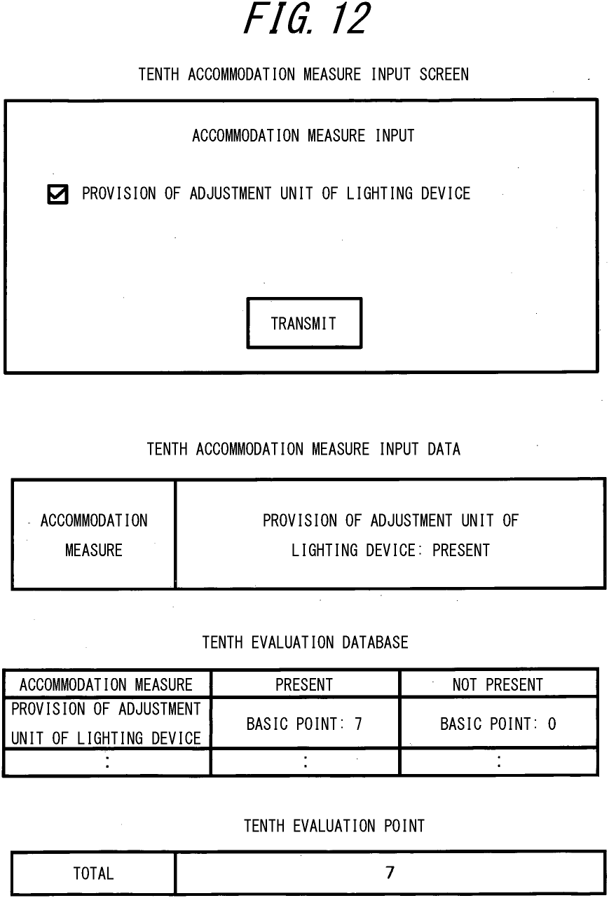

FIG. 12 illustrates a tenth example of the accommodation measure input process (STEP1) and the evaluation point calculation process (STEP2), and illustrates a tenth accommodation measure input screen, tenth accommodation measure input data, a tenth evaluation database, and a tenth evaluation point.

### Accommodation Measure Input Process

The tenth accommodation measure input screen is an information input screen that is used when an accommodation measure (alternatively, an accommodation measure to be provided) that is provided to the employed person with disabilities is input from the provider terminal 2.

The provider terminal 2 accesses the accommodation management server 1 to acquire the tenth accommodation measure input screen (data that constitutes the input screen), and displays the input screen on a display monitor that is included in the provider terminal 2.

On the tenth accommodation measure input screen, whether an adjustment unit of the lighting device is provided with respect to a person with disabilities who is employed, is input.

The company provides the unit that adjusts the brightness, the tone, the direction, and the like. Therefore, the person in charge inputs information indicating “the provision of the adjustment unit of the lighting device” (here, the corresponding checkbox is checked), and clicks a send button.

Thus, the provider terminal 2 generates the tenth accommodation measure input data, and transmits it to the accommodation management server 1.

### Evaluation Point Calculation Process

The accommodation management server 1 that has received the tenth accommodation measure input data stores it in the storage device.

The tenth evaluation database is stored in the storage device of the accommodation management server 1. This is data serving as a basis for performing an evaluation of an accommodation measure adopted by the company and in which accommodation measures and corresponding scores are corresponded (associated) with each other, respectively.

The accommodation management server 1 searches and extracts each score (a score including a basic point and an added point) based on the received tenth accommodation input data (the process is similar to the case of the first evaluation point calculation).

Next, the accommodation management server 1 sums up the searched and extracted scores, and generates and creates the “tenth evaluation point: 7.

Thus, an accommodation measure that is adopted by the company and the like can be appropriately evaluated, and a suitable accommodation can be provided to persons in the minority groups.

Further, in this example, a case where the adjustment unit of the lighting device is provided (first accommodation measure) and a case where the adjustment unit thereof is not provided (second accommodation measure) are distinguished from each other, and a higher evaluation point is given to the case of the provision than the case of no provision (when the first accommodation measure is adopted, a high evaluation is given thereto by adding points). Some persons with disabilities have a symptom of being dazzled by normal illumination, for example, so that the provision of the adjustment unit of the lighting device needs to be regarded as important and promoted. Therefore, the suitable accommodation can be promoted in this way.

### Evaluation Related to Number of Barrier-Free Units

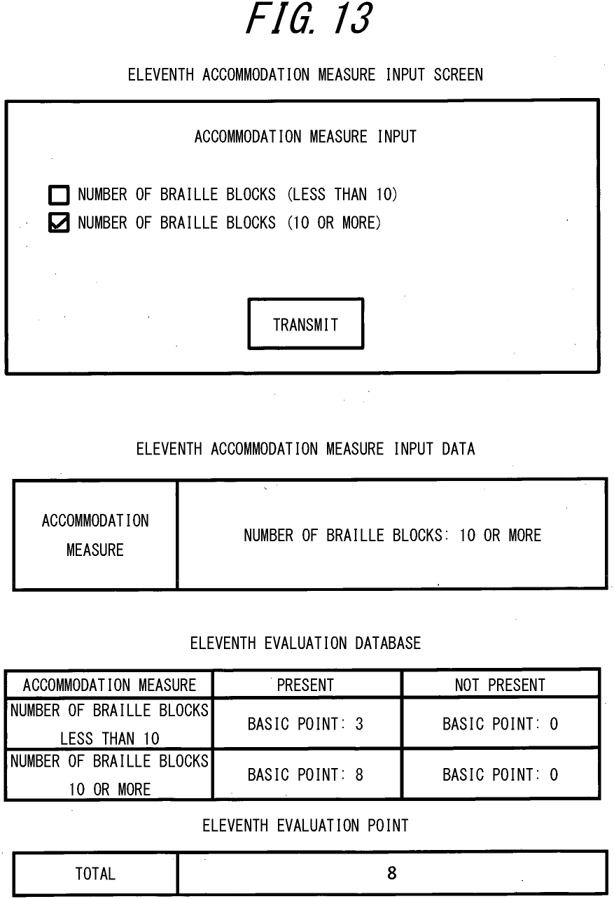

FIG. 13 illustrates an eleventh example of the accommodation measure input process (STEP1) and the evaluation point calculation process (STEP2), and illustrates an eleventh accommodation measure input screen, eleventh accommodation measure input data, an eleventh evaluation database, and an eleventh evaluation point.

### Accommodation Measure Input Process

The eleventh accommodation measure input screen is an information input screen that is used when an accommodation measure (alternatively, an accommodation measure to be provided) that is provided to the employed person with disabilities is input from the provider terminal 2.

The provider terminal 2 accesses the accommodation management server 1 to acquire the eleventh accommodation measure input screen (data that constitutes the input screen), and displays the input screen on a display monitor that is included in the provider terminal 2.

On the eleventh accommodation measure input screen, the number of barrier-free units such as braille blocks is input.

It is assumed that ten or more braille blocks are installed in the company. Therefore, the person in charge inputs information indicating “ten or more” (here, the corresponding checkbox is checked), and clicks a send button.

Thus, the provider terminal 2 generates the eleventh accommodation measure input data, and transmits it to the accommodation management server 1.

### Evaluation Point Calculation Process

The accommodation management server 1 that has received the eleventh accommodation measure input data stores it in the storage device.

The eleventh evaluation database is stored in the storage device of the accommodation management server 1. This is data serving as a basis for performing an evaluation of an accommodation measure adopted by the company and in which accommodation measures and corresponding scores are corresponded (associated) with each other, respectively.

The accommodation management server 1 searches and extracts each score based on the received eleventh accommodation input data (the process is similar to the case of the first evaluation point calculation).

Next, the accommodation management server 1 sums up the searched and extracted scores, and generates and creates the “eleventh evaluation point: 8”.

Thus, an accommodation measure that is adopted by the company and the like can be appropriately evaluated, and a suitable accommodation can be provided to persons in the minority groups.

Further, in this example, a higher evaluation is given as the number of barrier-free units such as braille blocks (accommodation measures) increases to vary the evaluation.

In this way, the barrier-free unit can be enhanced, and the suitable accommodation can be promoted.

The barrier-free unit may include, in addition to the braille blocks, various elements, such as the audio assist, the provision of character information, and the sign language interpretation, that make the facility, the tool, the communication, and the like be barrier-free.

### Evaluation Related to Type of Barrier-Free Unit

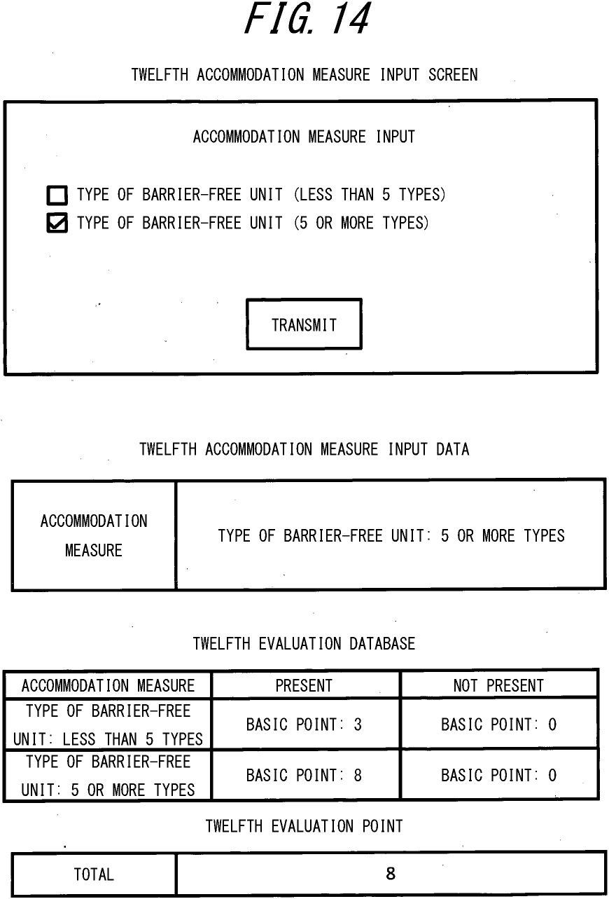

FIG. 14 illustrates a twelfth example of the accommodation measure input process (STEP1) and the evaluation point calculation process (STEP2), and illustrates a twelfth accommodation measure input screen, twelfth accommodation measure input data, a twelfth evaluation database, and a twelfth evaluation point.

### Accommodation Measure Input Process

The twelfth accommodation measure input screen is an information input screen that is used when an accommodation measure (alternatively, an accommodation measure to be provided) that is provided to the employed person with disabilities is input from the provider terminal 2.

The provider terminal 2 accesses the accommodation management server 1 to acquire the twelfth accommodation measure input screen (data that constitutes the input screen), and displays the input screen on a display monitor that is included in the provider terminal 2.

On the twelfth accommodation measure input screen, the degree of the number of types (the number) of the barrier-free units such as the braille blocks and the tools for communication by writing, are input.

In the company, five or more types of barrier-free units are installed. Therefore, the person in charge inputs information indicating “5 or more types” (here, the corresponding checkbox is checked), and clicks a send button.

Thus, the provider terminal 2 generates the twelfth accommodation measure input data, and transmits it to the accommodation management server 1.

### Evaluation Point Calculation Process

The accommodation management server 1 that has received the twelfth accommodation measure input data stores it in the storage device.

The twelfth evaluation database is stored in the storage device of the accommodation management server 1. This is data serving as a basis for performing an evaluation of an accommodation measure adopted by the company and in which accommodation measures and corresponding scores are corresponded (associated) with each other, respectively.

The accommodation management server 1 searches and extracts each score based on the received twelfth accommodation input data (the process is similar to the case of the first evaluation point calculation).

Next, the accommodation management server 1 sums up the searched and extracted scores, and generates and creates the “twelfth evaluation point: 8”.

Thus, an accommodation measure that is adopted by the company and the like can be appropriately evaluated, and a suitable accommodation can be provided to persons in the minority groups.

Further, in this example, a higher evaluation is given by adding points as the number of types of barrier-free units such as braille blocks (accommodation measures) increases to vary the evaluation.

In this way, the types of the barrier-free units can be enhanced, and the suitable accommodation can be promoted.

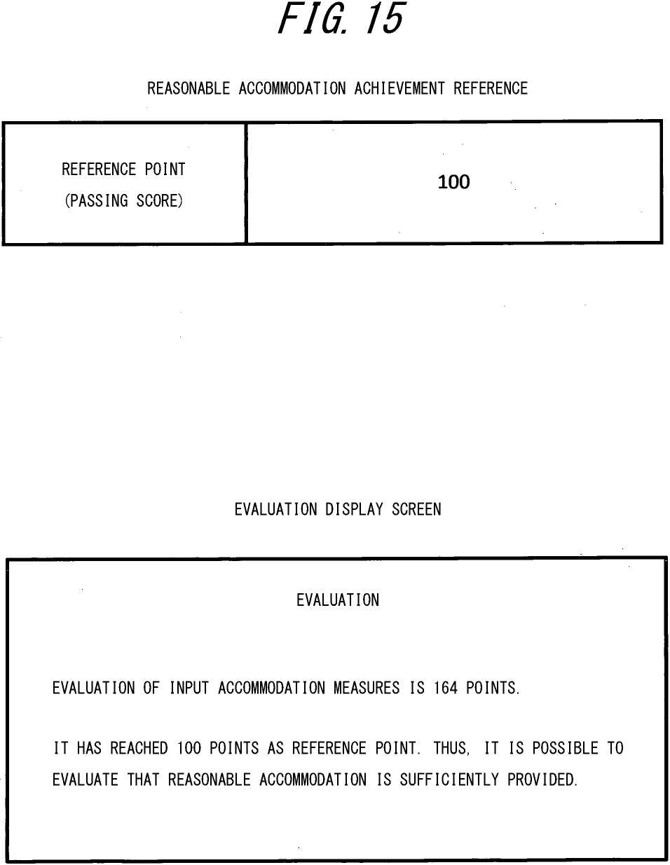

FIG. 15 illustrates data indicating a reasonable accommodation achievement reference point (a score that can be determined as having reached a reasonable accommodation), and here, 100 points are regarded as a reference point.

The accommodation management server 1 sums up the first to twelfth evaluations above to calculate 164 points as a total evaluation point, creates, by combining the comment stored in advance in the storage device and the score, evaluation comment data (a final determination evaluation including a plurality of evaluation elements) “An evaluation of the input accommodation measures is 164 points. It has reached 100 points as the reference point. Thus, it is possible to evaluate that a reasonable accommodation is sufficiently provided”, and transmits (outputs) the evaluation comment data to the provider terminal 2 (the evaluation output unit). If the evaluation does not reach the reference point, the accommodation management server 1 creates evaluation comment data such as “The reasonable accommodation is insufficient.”

The provider terminal 2 that has received the evaluation comment data stores the evaluation comment data in the storage device, and displays the evaluation comment data on the display monitor as in FIG. 13.

Thus, the person in charge can know the evaluation of the accommodation measures of his/her company.

The abovementioned twelve examples are merely examples, and only a part of which can be evaluated. Further, the evaluation can be received by inputting accommodation measures other than those of the abovementioned twelve examples.

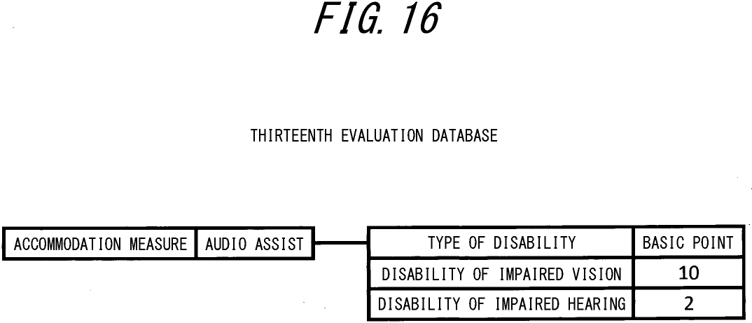

In FIG. 16, the evaluation of an accommodation measure is varied in accordance with the type of the disability. In a case where the type of the disability is the disability of impaired vision, the audio assist is effective and 10 points are indicated as the evaluation point. However, even as for the accommodation measure of the same audio assist, in a case where the type of the disability is the disability of impaired hearing, the audio assist is not effective and thus 2 points are indicated as the evaluation point.

When the evaluation of the accommodation measure is varied in accordance with the type of the disability in this way, a more detailed evaluation can be provided and the evaluation becomes suitable.

Although a specific case has been described in the above example, the present disclosure is not limited to the above example. For example, other hardware, other data or data items, other processing procedures/processing contents, other display contents, or the like may be used, as long as they can fulfill the same role.

Outputting the data may include transmitting the data, printing the data, displaying the data on the display monitor, or the like. Further, the data transmitted/received between the devices is stored in the storage devices of the devices.

In the above-mentioned example, the processes are performed via the Internet, but may be performed by one computer.

### REFERENCE SIGNS LIST

1 accommodation management server
2 provider terminal

1. An accommodation measure evaluation device comprising:
an accommodation measure evaluation data acquisition unit configured to acquire accommodation measure evaluation data that associates an accommodation measure for a person to be accommodated with an evaluation of the accommodation measure;
an accommodation measure acquisition unit configured to acquire the accommodation measure for the person to be accommodated;
an evaluation generation unit configured to generate an evaluation of the accommodation measure acquired by the accommodation measure acquisition unit based on the accommodation measure acquired by the accommodation measure acquisition unit and the accommodation measure evaluation data acquired by the accommodation measure evaluation data acquisition unit; and
an evaluation output unit configured to output the evaluation generated by the evaluation generation unit, wherein
the accommodation measure comprises a first accommodation measure and a second accommodation measure, and
a higher evaluation is given to an evaluation of the first accommodation measure than an evaluation of the second accommodation measure.

2. The accommodation measure evaluation device according to claim 1, wherein the person to be accommodated comprises a person with disabilities, or an elderly person, or a foreign national.

3. The accommodation measure evaluation device according to claim 1, wherein the accommodation measure comprises barrier-free of a facility or barrier-free of an instrument.

4. The accommodation measure evaluation device according to claim 1, wherein
the person to be accommodated comprises a person with disabilities, and
the evaluation of the accommodation measure varies in accordance with a type of the disability of the person with disabilities.

5-6. (canceled)

7. The accommodation measure evaluation device according to claim 1, wherein
the first accommodation measure includes an emergency accommodation measure that is necessary in an emergency, and
the second accommodation measure includes a peacetime accommodation measure that is necessary in peacetime.

8. (canceled)

9. The accommodation measure evaluation device according to claim 1, wherein
the first accommodation measure includes an accommodation measure that is necessary for a physiological phenomenon, and
the second accommodation measure includes an accommodation measure that is necessary for a non-physiological phenomenon.

10. (canceled)

11. The accommodation measure evaluation device according to claim 1, wherein
the first accommodation measure includes an accommodation measure that is necessary in an excretion action, and
the second accommodation measure includes an accommodation measure that is necessary in a non-excretion action.

12. (canceled)

13. The accommodation measure evaluation device according to claim 1, wherein
The first accommodation measure includes an accommodation measure that is necessary in an eating and drinking action, and
the second accommodation measure includes an accommodation measure that is necessary in a non-eating and drinking action.

14. (canceled)

15. The accommodation measure evaluation device according to claim 1, wherein
the first accommodation measure includes an audio assist for a person with impaired vision, and
the second accommodation measure includes braille display for the person with impaired vision.

16. (canceled)

17. The accommodation measure evaluation device according to claim 1, wherein
the first accommodation measure includes provision of character information for a person with impaired hearing, and
the second accommodation measure includes provision of sign language interpretation for the person with impaired hearing.

18. (canceled)

19. The accommodation measure evaluation device according to claim 1, wherein
the first accommodation measure includes an accommodation measure with accreditation accredited by a specialized institution or an expert, and
the second accommodation measure includes a non-accredited accommodation measure with no accreditation by the specialized institution or the expert.

20. (canceled)

21. The accommodation measure evaluation device according to claim 1, wherein
the first accommodation measure includes provision of a device subjected to automation, and
the second accommodation measure includes provision of a device not subjected to automation.

22. The accommodation measure evaluation device according to claim 21, wherein
the device subjected to automation comprises
an automatically opening and closing door,
an automatic lock door,
an elevator,
a chair that automatically moves up and down, or
a desk that automatically moves up and down.

23. (canceled)

24. The accommodation measure evaluation device according to claim 1, wherein
the first accommodation measure includes a selection type accommodation measure that provides a selection right to the person to be accommodated, and
the second accommodation measure includes a non-selection type accommodation measure in which the person to be accommodated has no selection right.

25. The accommodation measure evaluation device according to claim 24, wherein
the selection type accommodation measure comprises
selection of an information transmission unit,
selection of furniture,
selection of an office equipment,
selection of an office supply including stationery, or
selection of a payment system.

26. (canceled)

27. The accommodation measure evaluation device according to claim 1, wherein
the first accommodation measure includes implementation of a training for encouraging an employee or a staff member who accepts the person to be accommodated to understand of the person to be accommodated, and
the second accommodation measure includes non-implementation of the training.

28. (canceled)

29. The accommodation measure evaluation device according to claim 1, wherein
the first accommodation measure includes an accommodation measure that enables adjustment of a lighting device, and
the second accommodation measure includes an accommodation measure incapable of the adjustment of the lighting device.

30-31. (canceled)

32. An accommodation measure evaluation method, wherein a computer performs the following steps:
an accommodation measure evaluation data acquisition step for acquiring accommodation measure evaluation data that associates an accommodation measure for a person to be accommodated with an evaluation of the accommodation measure;
an accommodation measure acquisition step for acquiring the accommodation measure for the person to be accommodated;
an evaluation generation step for generating an evaluation of the accommodation measure acquired by the accommodation measure acquisition step based on the accommodation measure acquired by the accommodation measure acquisition step and the accommodation measure evaluation data acquired by the accommodation measure evaluation data acquisition step; and
an evaluation output step for outputting the evaluation generated by the evaluation generation step, wherein
the accommodation measure comprises a first accommodation measure and a second accommodation measure, and
a higher evaluation is given to an evaluation of the first accommodation measure than an evaluation of the second accommodation measure.

33. A non-transitory computer-readable media storing computer-readable instructions that when executed by one or more processors cause the one or more processors to perform operations, the operations comprising;
an accommodation measure evaluation data acquisition step for acquiring accommodation measure evaluation data that associates an accommodation measure for a person to be accommodated with an evaluation of the accommodation measure;
an accommodation measure acquisition step for acquiring the accommodation measure for the person to be accommodated;
an evaluation generation step for generating an evaluation of the accommodation measure acquired by the accommodation measure acquisition step based on the accommodation measure acquired by the accommodation measure acquisition step and the accommodation measure evaluation data acquired by the accommodation measure evaluation data acquisition step; and
an evaluation output step for outputting the evaluation generated by the evaluation generation step, wherein
the accommodation measure comprises a first accommodation measure and a second accommodation measure, and
a higher evaluation is given to an evaluation of the first accommodation measure than an evaluation of the second accommodation measure.
